(19) United States
(12) Patent Application Publication
(10) Pub. No.: US 2016/0072986 A1
(43) Pub. Date: Mar. 10, 2016

(54) BODY PART IMAGING SYSTEM

(71) Applicant: John JONES, San Francisco, CA (US)

(72) Inventor: John JONES, San Francisco, CA (US)

(21) Appl. No.: 14/663,170

(22) Filed: Mar. 19, 2015

Related U.S. Application Data
(60) Provisional application No. 61/987,413, filed on May 1, 2014.

(51) Int. Cl. H04N 5/225; H04N 17/00; H04N 5/262; H04N 7/18; H04N 5/247

(52) U.S. Cl. CPC H04N 5/2252; H04N 7/183; H04N 5/247; H04N 5/2628; H04N 17/002

(57) ABSTRACT

A device having an array of optical imagers, said imagers disposed near a substantially planar optically transparent medium with an array of calibration indicia disposed within the optical range of at least one of the imagers, said calibration indicia including a plurality of images spaced a predetermined distance from each other. Also included are skew indicia, which may include a plurality of images spaced a predetermined angle from each other, and a processor, coupled to the array of optical imagers and operable to process information from the imagers. Certain embodiments have the calibration and skew indicia etched into the transparent medium and include a chamber with a light source for capturing images.

### PRIORITY

This application claims the benefit of pending provisional patent application 61/987,413 entitled “Body Part Imaging System” filed May 1, 2014 by the same inventor which is included by reference as if fully set forth herein.

### SUMMARY

Disclosed herein are systems and methods for imaging body parts using digital photography and using those images to create actual sized models for 3D printing. The actual models may in turn be used for manufacturing clothing such as gloves, bras and footwear.

further disclosed herein is a device having an array of optical imagers, said imagers disposed near a substantially planar optically transparent medium with an array of calibration indicia disposed within the optical range of at least one of the imagers, said calibration indicia including a plurality of images spaced a predetermined distance from each other. Also included are skew indicia, which may include a plurality of images spaced a predetermined angle from each other, and a processor, coupled to the array of optical imagers and operable to process information from the imagers. Certain embodiments have the calibration and skew indicia etched into the transparent medium and include a chamber with a light source for capturing images.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 shows a functional block diagram of a client server system that may be employed for some embodiments according to the current disclosure.

FIG. 2 illustrates an embodiment of a device for capturing an image of a body part.

FIG. 3 shows an image of calibration lines which may be placed on the side walls of an imaging chamber.

FIG. 4 represents an image which may be taken of a top view of a body part.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The terms “raster graphics, “raster image”” and the like generally refer to a bitmap or dot matrix type structure representing a generally rectangular grid of pixels, or points of color, which may be visualized with a monitor, paper, or other display medium.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

The term “virtual machine” or “VM” generally refers to a self-contained operating environment that behaves as if it is a separate computer even though it is part of a separate computer or may be virtualized using resources form multiple computers.

The terms “vector image” or “vector graphics” generally refer to images which are constructed from geometrical primitives such as points, lines, curves, and shapes or polygon(s), which are all based on mathematical expressions. Vector graphics are based on vectors (also called paths, or strokes) which lead through locations called control points. Each of these points has a definite position on the x, y and z axes of a work space. Each point, as well, is an element of data structure, including the location of the point in the work space and the direction of the vector (which is what defines the direction of the track). Each track can be assigned a color, a shape, a thickness and often a fill.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The invention is not in any way limited to the specifics of any particular examples disclosed herein. Many other variations are possible which remain within the content, scope and spirit of the invention, and these variations would become clear to those skilled in the art after perusal of this application.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

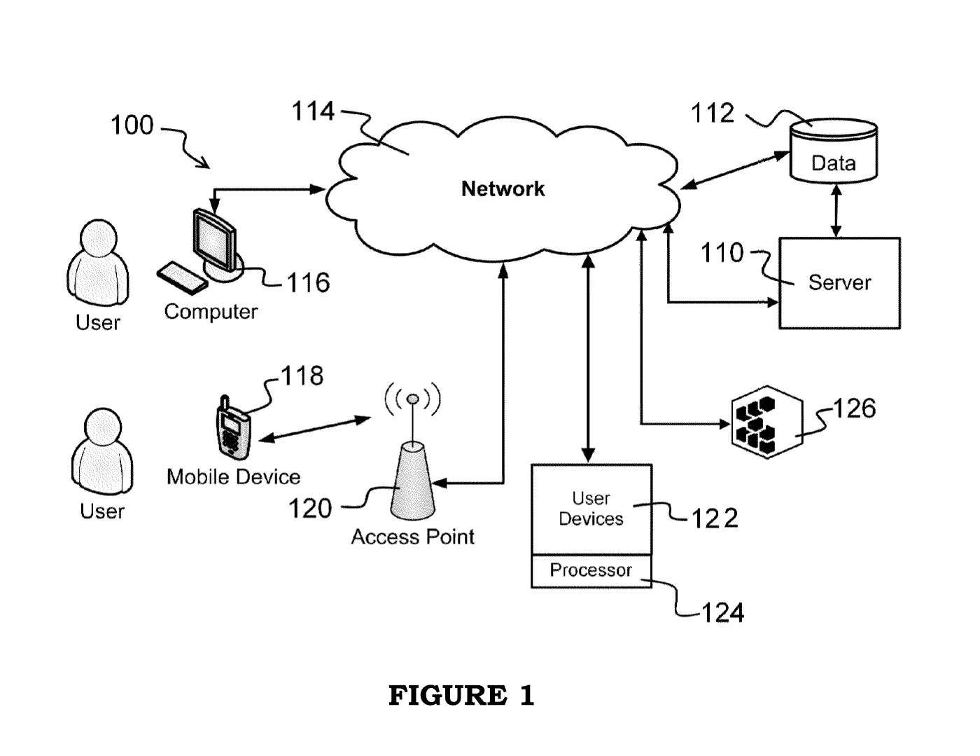

FIG. 1 shows a functional block diagram of a client server system 100 that may be employed for some embodiments according to the current disclosure. In FIG. 1 a server 110 is coupled to one or more databases 112 and to a network 114. The network may include routers, hubs and other equipment to effectuate communications between all associated devices. A user may access the server by a computer 116 communicably coupled to the network 114. The computer 116 may include a sound capture device such as a microphone (not shown). Alternatively the user may access the server 110 through the network 114 by using a smart device such as a telephone or PDA 118. The smart device 118 may connect to the server 110 through an access point 120, coupled to the network 14. The mobile device 118, may include a sound capture device such as a microphone.

User devices 122, such as cameras may be coupled to the network in certain embodiments, as well as “maker bots” such as three dimensional (3D) printers 126. It will be appreciated that additive manufacturing is a process for making a three-dimensional solid object from a digital model.

In FIG. 1 the devices that comprise the processing system may include local or dedicated processors to operate those devices. Software may be employed to control system elements and combine their functions to provide the embodiments describe herein. Some embodiments may employ software on various devices with the effect of producing a single result.

Some embodiments may include coupling a plurality of cameras to a local processor for image processing operations. These operations may include constructing three dimensional (3D) image files based data from multiple cameras. For example and without limitation, multiple cameras may collect images and, using a local processor, created a standard file formats such as Additive Manufacturing File Format (AMF) or ISO/ASTM 52915:2013. Once created, these files may be stored on a remote server and made available to any device for further operations such as 3D printing.

### Client Server Processing

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server may provide machine-readable instructions to the client device and the client device may execute those instructions. The interaction between the server and client may indicate which instructions are transmitted and executed. In addition, the client may, at times, provide for machine readable instructions to the server, which in turn may execute them. Several forms of machine readable instructions are conventionally known including applets and are written in a variety of languages, for example and without limitation Java and JavaScript.

Client-server applications also provide for software as a service (SaaS) applications where the server may provide software to the client on an as needed basis.

In addition to the transmission of instructions, client-server applications may also include transmission of data between the client and server. Often this entails data stored on the client to be transmitted to the server for processing. The resulting data may then be transmitted back to the client for display or further processing.

One having skill in the art will recognize that client devices may be communicably coupled to a variety of other devices and systems such that the client may receive data directly and subsequently operate on that data before transmitting it to other devices or servers. Thus data to the client device may, inter alia, come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine, a pattern recognition engine, and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

### Body Image Capturing

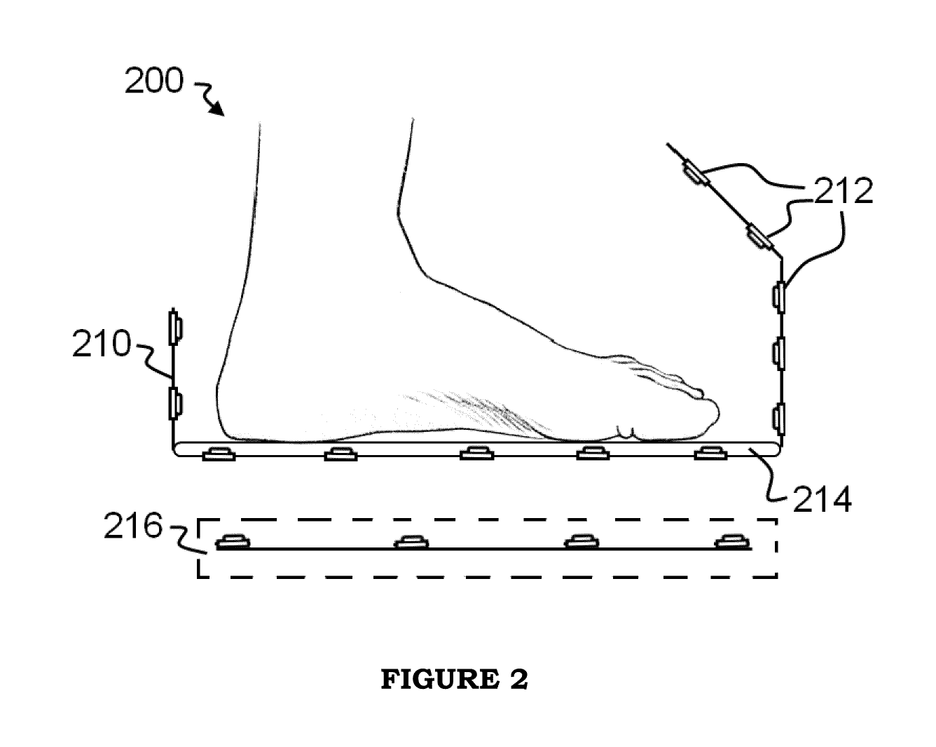

FIG. 2 illustrates an embodiment of a device 200 for capturing an image of a body part. The device 200 includes a chamber 210, large enough to contain the body part being characterized. In some embodiments the chamber may include a light source (not shown) for illuminating the body part. The chamber may be constructed of any shape that best provides imaging for the body part in question; as shown in FIG. 2 the chamber wall may be angled to allow for imaging of parts of a foot. On the walls of the chamber may be multiple cameras 212, directed towards the body part. Such cameras (or optical imagers) 212 may be positioned in a single or multi-dimensional array and spaced as necessary to achieve the desired level of measurement accuracy and reliability.

The bottom of the chamber 214 may be formed from a glass pane or some other optically transparent medium suitable for allowing imaging and strong enough for holding the desired weight. Some embodiments may have cameras embedded in or near the bottom, while other embodiments may have an array of cameras placed at a distance from the bottom 214. Such cameras may be positioned in a single or multi-dimensional array and spaced as necessary to achieve the desired level of measurement accuracy and reliability. Lighting may be effectuated using ambient light or lights sources (such as LEDs and the like) may be affixed to the chamber to provide for adequate illumination.

In operation, the cameras 212 may be operated to take an image simultaneously having the effect that the resulting images include different angles of the same body part at the same time. The resulting image may be stored in memory for later processing.

The transparent bottom 214 allows for imaging a body part in a normal posture position. For example and without limitation, the image of a foot (as shown) may be effectuated under the weight of a user. The geometry of the foot is likely to be different when supporting the individual's mass as compared to the foot when it is not under load i.e. not supporting the individual's mass. Thus, the glass bottom 214 may have the affect of providing a more accurate image of the foot, in a normal posture position, than devices that capture images when the individual is not in a not in a normal posture position i.e. standing up.

### Image Analysis

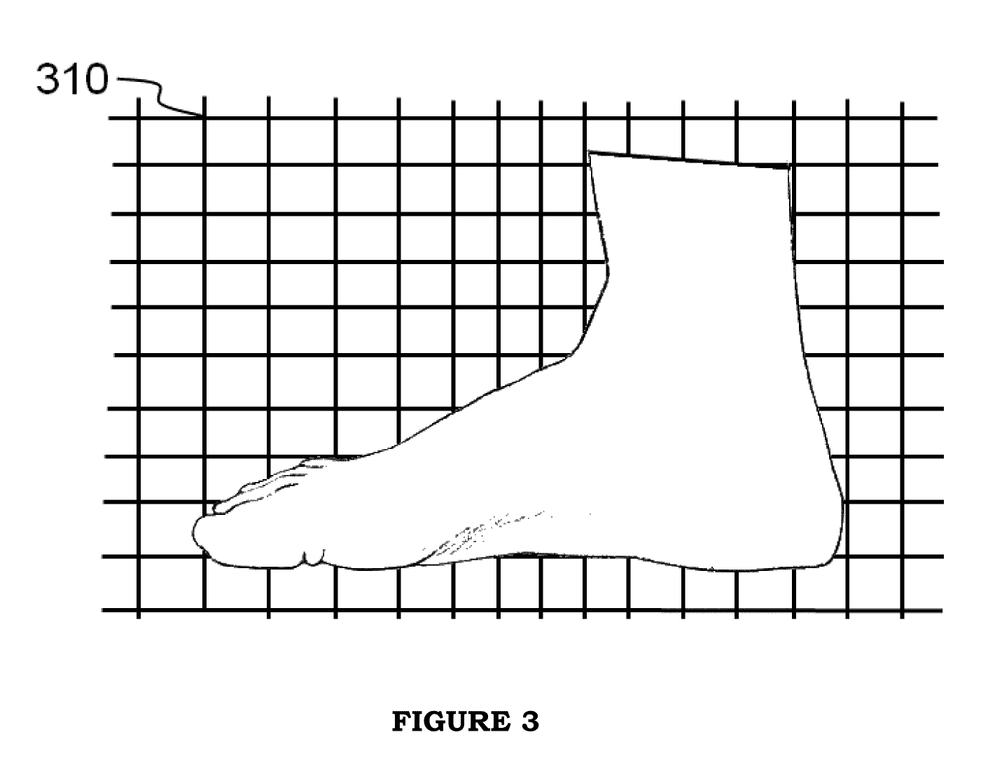

FIG. 3 shows an image of calibration lines (or grid) 310, which may be placed on the side walls of an imaging chamber. The calibration lines 310 or other indicia, may be evenly spaced i.e. a fixed and known, distance apart or other known predetermined distance apart. A body part such as a foot (as shown), when imaged using a camera will obscure a portion of the calibration line 310 having the effect of providing a reference point which may be used to measure the size of the body part in the image. In addition, the relative sizes of the body part may be determined. For example and without limitation, the maximum width and/or inner arch relative dimensions may be calculated. When the calibration lines 310 are provided on the side of the imaging chamber, the exact distance to the calibration lines is known.

Imaging with multiple cameras may enhance the ability to calculate sizes. The accuracy of the measurement calculations may depend on the spacing of the calibration lines 310 and the position and quality of the camera. For example and without limitation, spacing the cameras at equal distances may facilitate calculation. Moreover, since the calibration lines 310 are at a known and fixed distance, trigonometric functions may be employed for triangulation and determining size. The fundamental principle used by photogrammetry is triangulation. By taking photographs from at least two different locations, so-called “lines of sight” can be developed from each camera to points on the object. These lines of sight are mathematically intersected to produce the 3-dimensional coordinates of the points of intersection.

In some embodiments a user may capture an image using a camera on a mobile device, perform object recognition on a portion of the image. The object recognition may be performed at the camera level or image information may be transmitted to a server for recognition. In some embodiments multiple images may be “stitched” together to form a composite image for analysis. Other embodiments may employ backlit or colored chamber walls and calibration lines 310 to improve image size calculations.

Even other embodiments may include calibrations sizes for comparisons. In these embodiments known sizes may be stored in a calibration table which may then be used for comparing to an image. Actual size may be extrapolated. Image analysis software is conventionally available for effectuating techniques for creating digital models of a given body part under consideration.

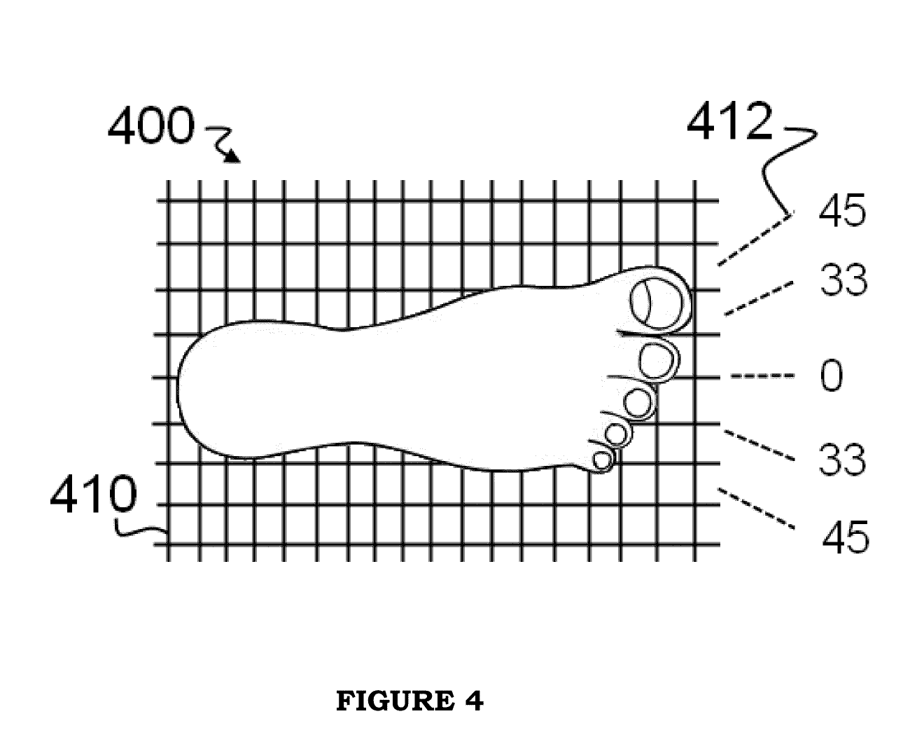

FIG. 4 represents an image which may be taken of a top view 400 of a body part. The images and techniques of the top view may also be applied to any side and to a bottom image. On the top view, skewing, of the body part (from grid alignment) and size may be measured by placing the object against calibration lines 410. Included in these calibration lines may be angular calibration lines 412.

In operation, a user may place their foot (the target image) in the chamber placing their weight onto the foot. The foot, being applied directly to the bottom of the chamber will be essentially at a known distance from the calibration lines 410. In some embodiments, the calibration lines 410 may be etched into or disposed on the floor of the chamber. Accordingly, measure of foot length and width may be effectuated by directly reading the scale. Correction for skewing may be effectuated using the angular calibration lines 412, which may also be etched onto or otherwise disposed on the surface of the floor of the chamber. In addition compression of the foot under weight may alter the shape of the arch of the foot, and calibration allows for measuring the arch under normal load conditions. Simple trigonometric functions may be employed to get foot size. As an example, a foot is shown in FIG. 4; this disclosure should not be read as limiting in any way because other body parts, including part of animals and objects may still be operated on using the techniques and systems described herein

By calculating the location of the edges of the body part, more accurate distance information can be applied to side view angles to help calculate relative size, and through the use of calibration information, calculate actual size of the object of the target image. Also, since the foot would have the weight of the person, any expansion of foot size under stress would be reflected in the measurements.

In some embodiments the camera angle may not be directly on center as shown in FIG. 4. In these embodiments similar techniques may be employed to correct for skewing.

### 3D Printing

3D printing or additive manufacturing is a process of making a three-dimensional solid object of virtually any shape from a digital model. 3D printing is achieved using an additive process, where successive layers of material are laid down in different shapes. Conventionally, 3D printing is considered distinct from traditional machining techniques, which mostly rely on the removal of material by methods such as cutting or drilling (a subtractive processes), however, there are commercial machines that perform both additive and subtractive processes.

A digital model may be formed once an image of a body part is captured. Modeling is the process of developing a mathematical representation of any three-dimensional surface of object (either inanimate or living). The 3D model can be displayed as a two or three-dimensional image through a process called 3D rendering or used in a computer simulation of physical phenomena. The model can also be physically created using 3D printing devices. 3D models represent a 3D object using a collection of points in 3D space, connected by various geometric entities such as triangles, lines, curved surfaces, etc.

To perform a 3D print, a machine reads the design from 3D printable file (such as an STL file) and lays down successive layers of liquid, powder, paper or sheet material to build the model from a series of cross sections. These layers, which correspond to the virtual cross sections from a computer-aided design (CAD) model, are joined or automatically fused to create the final shape. The primary advantage of this technique is its ability to create almost any shape or geometric feature.

Some embodiments may include a 3D printer for creating a mold. This mold is a representation of the body part. A “last” is a mechanical form that has a shape similar to that of a human foot. It is used by shoemakers and cordwainers in the manufacture and repair of shoes. Lasts typically come in pairs, and have been made from various materials, including hardwoods, cast iron, and, high density plastics. In certain embodiments a last may be 3D printed using a suitable material. The last may then be employed in the manufacture of custom-made footwear. Similar to a last, a mold for manufacturing.

This application should not be construed as limiting the 3D process in any way. For example, the 3D printing step may be in addition to subtractive processes or a basic form may be used for constructing the last and subtractive and/or additive process used to alter that form.

In one possible operational example, a user may place a body part, such as a foot into one of the devices, as described herein, where an image of the foot may be taken. The image may then be analyzed to create the 3D model of the relevant parts of the foot. The 3D model file may then be transmitted to a manufacturing facility where the last is printed. Once printed the last may be used to construct custom footwear which may then be shipped to the user.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

I claim:

1. A device including:
an array of optical imagers, said imagers disposed near a substantially planar optically transparent medium;
an array of calibration indicia disposed within the optical range of at least one of the imagers, said calibration indicia including a plurality of images spaced a predetermined distance from each other;
an array of skew indicia, said skew indicia including a plurality of images spaced a predetermined angle from each other, and
a processor, said processor coupled to a memory and to the array of optical imagers and operable to process information from the imagers.

2. The device of claim 1 wherein the calibration indicia is etched into the transparent medium.

3. The device of claim 1 wherein the skew indicia is etched into the transparent medium.

4. The device of claim 1 further including a chamber, said chamber encapsulating a portion of the transparent medium.

5. The device of claim 4 wherein the chamber includes a light source.

6. The device of claim 1 wherein the memory includes processor readable instructions directing the processor to perform a method including:
reading image information from the optical imagers;
calculating relative dimensions of an object of the image information, and
generating a multi-dimensional image file representing the object of the image information.

7. The device of claim 6 wherein the method further includes:
scaling the dimension information to an actual size, and
skewing the image information.

8. The device of claim 6 further including a network interface, said network interface operable to transmit the multi-dimensional image file to a remote device.

9. The device of claim 1 wherein the optical imagers are disposed at a uniform distance apart.

10. The device of claim 1 wherein the optical imagers are disposed on the transparent medium.

11. A method comprising:
placing a body part on a transparent surface;
imaging the body part with a plurality of optical imagers, said imagers disposed to image a calibration indicia and a skew indicia;
calculating a relative dimension of the body part;
generating a multi-dimensional image information in response to the calculating;
skewing the multi-dimensional image information;
scaling the relative dimension to an actual size, and
transmitting the multi-dimensional image information to a remote device.

12. The method of claim 11 wherein the calibration indicia is etched into the transparent surface.

13. The device of claim 11 wherein the skew indicia is etched into the transparent surface.

14. The device of claim 11 wherein the imaging is affected in a chamber, said chamber encapsulating a portion of the transparent surface.

15. The device of claim 14 wherein the chamber includes a light source.
